(19) United States
(12) Patent Application Publication
(10) Pub. No.: US 2007/0267797 A1
(43) Pub. Date: Nov. 22, 2007

(54) Clamping device

(76) Inventors: Kazuhide Iwata, Mino-shi (JP); Hitoshi Mabuchi, Mino-shi (JP)

Correspondence Address: JORDAN AND HAMBURG LLP, 122 EAST 42ND STREET, SUITE 4000, NEW YORK, NY, 10168, US

(21) Appl. No.: 11/715,732

(22) Filed: Mar. 8, 2007

(30) Foreign Application Priority Data
May 19, 2006 (JP) 2006-140837

(51) Int. Cl. B25B 5/02

(52) U.S. Cl. 269/86

(57) ABSTRACT

A clamping device has a base body, a pressing body for pressing a workpiece and a rotationally operable rotary body, all of which are rotatable relative to each other about an axis. The pressing body can rotate between a first rotary position at which the pressing body does not face the workpiece and a second rotary position at which the pressing body faces the workpiece. The pressing body can move between a press releasing position and a pressing position while being at the second rotary position. When the rotary body is rotated from one rotary position to a middle rotary position, the pressing body rotates from the first rotary position to the second rotary position as the rotary body rotates. When the rotary body is rotated to another rotary position, the pressing body is moved from the press releasing position to the pressing position by a cam mechanism.

### BACKGROUND OF THE INVENTION

This invention relates to a clamping device for fixing an object to be clamped such as, for example, a workpiece to a fixing base such as, for example, a fixture base or a machine table.

Conventionally, for example, as shown in FIG. 13, there has been a clamping device 21 that functions as a device for fixing a workpiece as an object to be clamped to a fixing base such as a fixture base, a pallet for machining center, a machine table or the like (for example, see Patent Document 1). The clamping device 21 includes a main body 22, a pressing body 23 for pressing the workpiece 20 and a rotary body 24 having an operating handle 24a which are assembled together for rotational movement relative to each other about an axis 25. A pin 22a projects from a top surface of the main body 22. The pin 22a enters a recess 23a of the pressing body 23 to limit a rotary range of the pressing body 23 to a preset range. A coil spring 27 extends between the main body 22 and the pressing body 23 via an outer tubular member 26. The coil spring 27 pushes the pressing body 23 against a head portion 24b of the rotary body 24. The main body 22 has a slot 22b inclining relative to a horizontal plane. A guide pin 24c coupled with the rotary body 24 engages with the slot 22b. Because of this arrangement, when the rotary body 24 is operated to rotate, the pressing body 23 rotates as the rotary body 24 rotates, to a position at which the pressing body 23 faces the workpiece 20. At this moment, the pin 22a and the recess 23a engage with each other to prevent the pressing body 23 from rotating further. When the rotary body 24 is operated to rotate further, the rotary body 24 descends via the guide pin 24c guided by the slot 22b, and the rotary body 24 pushes the pressing body 23 to also descend and to press the workpiece 20.

[Patent Document 1] JP-A-2004-314222

Meanwhile, in the conventional clamping device 21, the guide pin 24c and the slot 22b have line contact with each other. Such a narrow contact along the line needs to receive the entire load generated while the pressing body 23 presses the workpiece 20. It has been, thus, difficult to increase the pressing load. This invention is made to solve the conventional drawback, and an object thereof is to provide a clamping device that can easily increase the pressing load.

### SUMMARY OF THE INVENTION

The clamping device in accordance with a first aspect of this invention has the following construction to achieve the object. That is:

the clamping device of the invention is a clamping device for fixing an object to be clamped to a fixing base, and comprises a base body that can be detachably fixed to the fixing base, a pressing body that can press the object, and a rotationally operable rotary body. The base body, the pressing body and the rotary body are coupled with each other for rotational movement relative to each other about an axis. The pressing body is rotatable between a first rotary position at which the pressing body does not face the object in the same direction as a direction of the axis and a second rotary position at which the pressing body faces the object in the same direction as the direction of the axis. The rotary body is rotatable between one rotary position on a side of the first rotary position and another rotary position beyond a middle rotary position on a side of the second rotary position. The pressing body is movable between a press releasing position on a press releasing side and a pressing position on a pressing side, in the same direction as the direction of the axis, so that the pressing body presses the object and releases the press at the second rotary position. In this connection, the clamping device further comprises a contact means, a holding means, a rotary range limiting means and an interlocking means. The contact means makes the pressing body and the rotary body contact each other so that the pressing body rotates as the rotary body rotates between the first rotary position and the second rotary position. The holding means holds the pressing body at the press releasing position between the first rotary position and the second rotary position. The rotary range limiting means prevents the pressing body from rotating to a side opposite the first rotary position from the second rotary position. The interlocking means moves the pressing body positioned at the second rotary position between the press releasing position and the pressing position in interlocking with the rotational movement of the rotary body between the middle rotary position and the other rotary position. The interlocking means includes a cam mechanism having a cam surface and a contact section contacting the cam surface, and the cam mechanism is configured in such a manner that the cam surface and the contact section have surface contact with each other at least when the pressing body is positioned at the pressing position.

When the rotary body is rotated from the one rotary position to the middle rotary position, the pressing body rotates from the first rotary position to the second rotary position as the rotary body is rotated by the contact means, while being held at the press releasing position by the holding means. When the rotary body is rotated from the middle rotary position to the other rotary position, the pressing body is moved from the press releasing position to the pressing position by the interlocking means, while being held at the second rotary position by the rotary range limiting means, to press the object.

Regarding the clamping device, when the object to be clamped is fixed to the fixing base, the rotary body is operated to rotate from the one rotary position to the other rotary position beyond the middle rotary position after the object is placed at the position where the object is to be fixed. Thereby, the pressing body rotates from the first rotary position at which the pressing body does not face the object to the second rotary position at which the pressing body faces the object as the rotary body rotates to the middle rotary position. Then, with the rotational movement of the rotary body to the other rotary position, the pressing body moves from the press releasing position on the press releasing side to the pressing position on the pressing side, while being at the second rotary position, to press the object. Thus, the object is fixed to the fixing base. In this connection, the cam mechanism of the interlocking means is configured in such a manner that the cam surface and the contact section have surface contact with each other when the pressing body is positioned at the pressing position. The pressing load by which the workpiece is pressed thus can be easily increased.

In accordance with a second aspect of the clamping device of the invention, in the clamping device in accordance with the first aspect of this invention, the interlocking means comprises the cam mechanism. One of the pressing body and the rotary body has the cam surface and the other thereof has the contact section. As thus constructed, i.e., because the cam mechanism which functions as the interlocking means is positioned between the pressing body and the rotary body, the pressing body moves in the same direction as the direction of the axis relative to the rotary body. Therefore, the pressing body can move between the press releasing position and the pressing position without the rotary body being moved in the same direction as the direction of the axis.

In accordance with a third aspect of the clamping device of the invention, in the clamping device in accordance with the second aspect of the invention, the contact means comprises a resilient member which resiliently urges so that the cam surface and the contact section tightly abut each other. Because the cam surface and the contact section tightly abut each other, the pressing body rotates between the first rotary position and the second rotary position as the rotary body rotates. No contact portion thus is necessary other than the cam mechanism.

In accordance with a fourth aspect of the clamping device of the invention, in the clamping device in accordance with the first aspect of the invention, an inclination of the cam surface of the cam mechanism is formed to move the pressing body rapidly on the side of the middle rotary position and to move the pressing body slowly on the side of the other rotary position in the rotational movement of the rotary body between the middle rotary position and the other rotary position. Thereby, the pressing body moves rapidly from the press releasing position toward the pressing position side and strongly presses the object at the pressing position.

In accordance with a fifth aspect of the clamping device of the invention, in the clamping device in accordance with the first aspect of the invention, the rotary range limiting means comprises a projection projecting from one of the base body and the pressing body and a recess in the other of the base body and the pressing body to allow the projection to move relative to the recess. When the pressing body rotates from the first rotary position to the second rotary position, the projection moves relative to and in the recess and abuts an end surface of the recess so that the pressing body is prevented from moving further.

In accordance with a sixth aspect of the clamping device of the invention, in the clamping device in accordance with the first aspect of the invention, the holding means comprises an urging body that urges the pressing body in a direction in which the pressing body moves from the pressing position to the press releasing position. Accordingly, the pressing body is urged toward the press releasing position side by the urging body so as to be held at the press releasing position between the first rotary position and the second rotary position.

Also, in accordance with a seventh aspect of the clamping device of the invention, in the clamping device in accordance with the first aspect of the invention, the rotary body comprises a camshaft defining the axis and an operating lever fixed to the camshaft by a bolt.

Further, in accordance with an eighth aspect of the clamping device of the invention, in the clamping device in accordance with the first aspect of the invention, a second cam surface is provided, the cam surfaces being spaced from each other by 180 degrees about the axis, and a second contact section is provided, the contact sections being spaced from each other by 180 degrees about the axis to correspond to the cam surfaces.

The cam mechanism of the clamping device of the present invention is configured in such a manner that the cam surface and the contact section thereof have surface contact with each other, to press a workpiece. The pressing load thus can be easily increased.

### BRIEF DESCRIPTION OF THE DRAWINGS

FIG. 1 is a perspective view of a clamping device configured in accordance with one embodiment of this invention.

FIG. 2 is a plan view of the clamping device, showing a condition under which a rotary body is placed at one rotary position and a pressing body is placed at a first rotary position and a press releasing position.

FIG. 3 is a cross sectional view of the clamping device taken along the line A-A of FIG. 2.

FIG. 4 is a plan view of the clamping device, showing another condition under which the rotary body is placed at a middle rotary position and the pressing body is placed at a second rotary position and the press releasing position.

FIG. 5 is a cross sectional view of the clamping device taken along the line B-B of FIG. 4.

FIG. 6 is an enlarged cross sectional view of the clamping device taken along the line C-C of FIG. 5.

FIG. 7 is a plan view of the clamping device, showing a further condition under which the rotary body is placed at another rotary position and the pressing body is placed at the second rotary position and a pressing position.

FIG. 8 is a cross sectional view of the clamping device taken along the line D-D of FIG. 7.

FIG. 9 is a perspective view of the pressing body.

FIG. 10 is a perspective view of cam surfaces of the pressing body.

FIG. 11 is a perspective view of a camshaft.

FIG. 12 illustrates schematic views of a cam mechanism.

FIG. 13 is a cross sectional view of a conventional clamping device.

### DETAILED DESCRIPTION OF THE INVENTION

With reference to drawings, a preferred embodiment of the clamping device according to this invention will be described below.

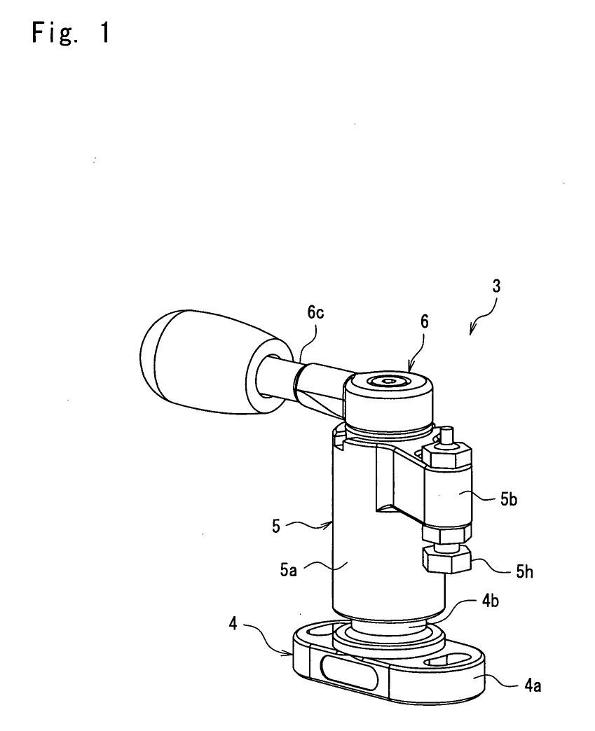

FIGS. 1-12 show one embodiment of this invention. The reference numeral 1 in those figures indicates a fixing base such as, for example, a fixture base mounted to a pallet or a table of machining tools, such as a machining center. The reference numeral 2 indicates a workpiece as an object to be clamped that is, for example, going to be machined. The reference numeral 3 indicates a clamping device for fixing the workpiece 2 to the fixing base 1.

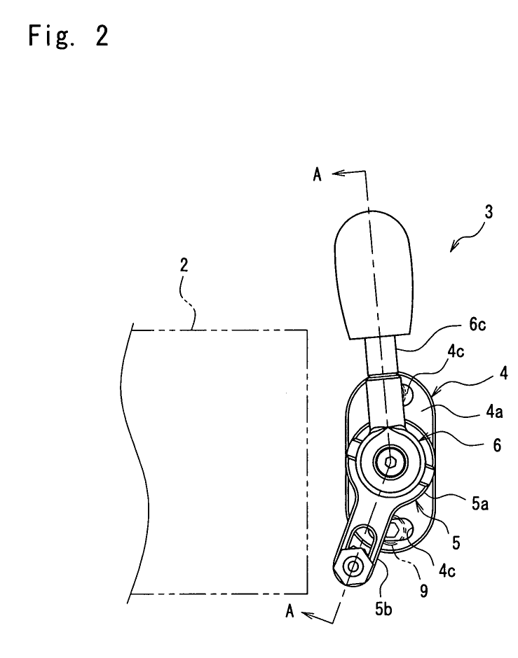

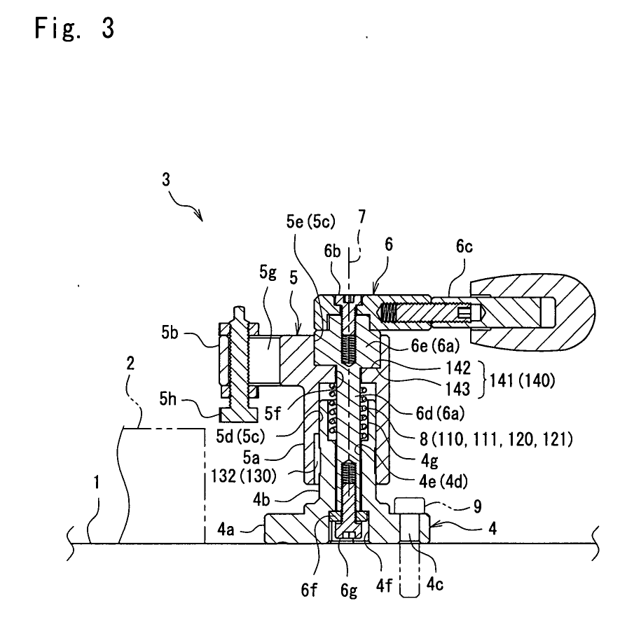

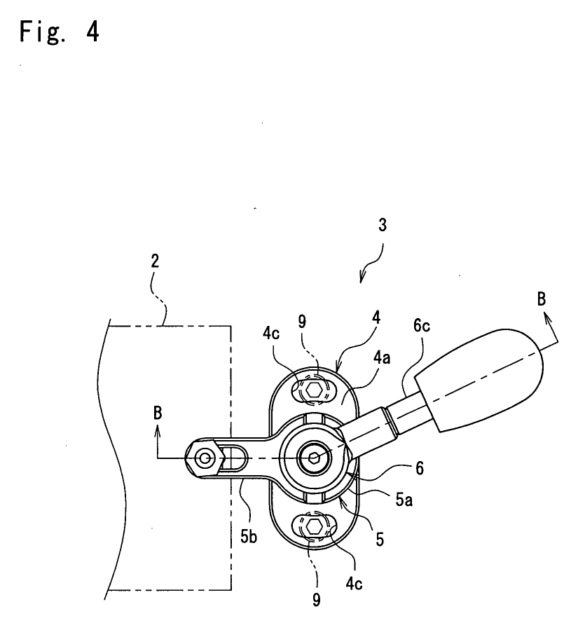

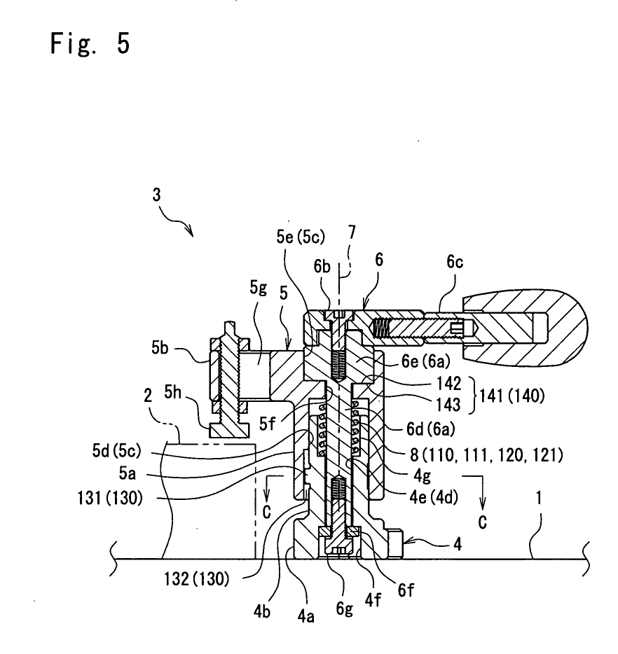

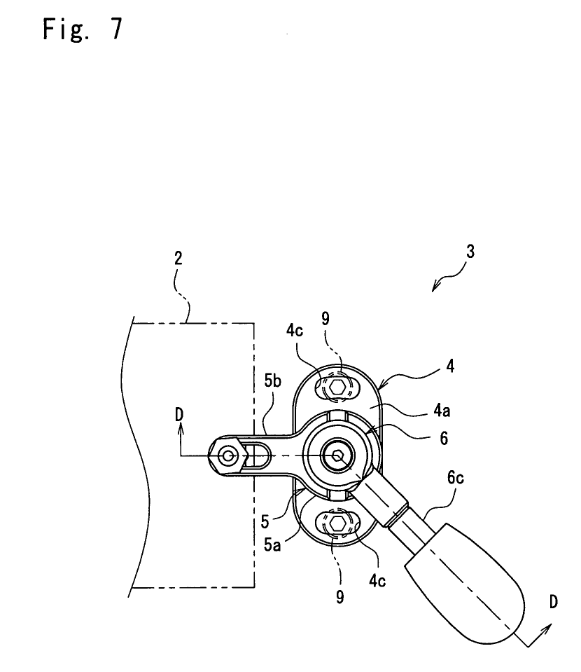

The clamping device 3 has a base body 4 detachably mounted to the fixing base 1, a pressing body 5 for pressing the workpiece 2 and a rotary body 6 which is operated to rotate. In this embodiment, the base body 4, the pressing body 5 and the rotary body 6 are assembled together for rotational movement relative to each other about an axis 7. The pressing body 5 thus is rotatable between a first rotary position (see FIGS. 2 and 3) at which the pressing body 5 does not face the workpiece 2 in the same direction as a direction of the axis 7 and a second rotary position (see FIGS. 4 and 5) at which the pressing body 5 faces the workpiece 2 in the same direction as the direction of the axis 7. Also, the rotary body 6 is rotatable between one rotary position (see FIG. 2) on a side of the first rotary position and another rotary position (see FIG. 7) beyond a middle rotary position (see FIG. 4) on a side of the second rotary position.

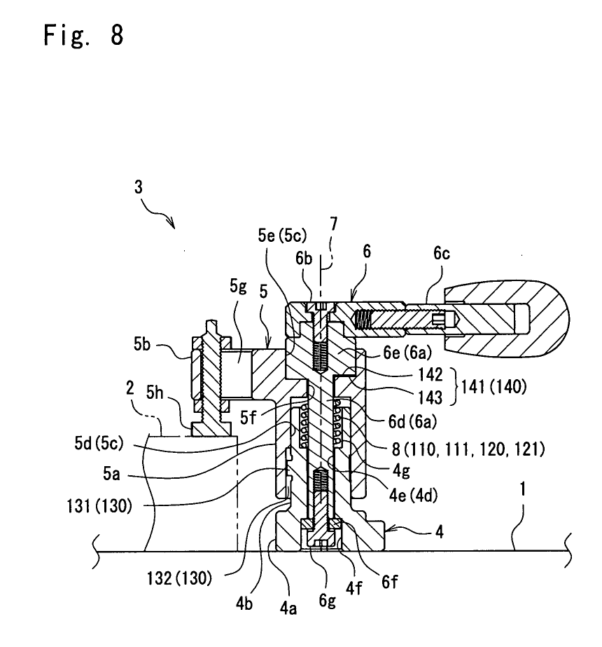

The pressing body 5 is movable between a press releasing position (see FIG. 5) on a press releasing side and a pressing position (see FIG. 8) on a pressing side, in the same direction as the direction of the axis 7, so that the pressing body 5 presses the workpiece 2 and releases the press at the second rotary position.

In this embodiment, the clamping device 3 includes a contact means 110, a holding means 120, a rotary range limiting means 130 and an interlocking means 140.

The contact means 110 makes the pressing body 5 and the rotary body 6 contact each other so that the pressing body 5 rotates as the rotary body 6 rotates between the first rotary position (see FIGS. 2 and 3) and the second rotary position (see FIGS. 4 and 5). Specifically, the contact means 110 includes a resilient member 111 which resiliently urges the pressing body 5 and the rotary body 6 so that the pressing body 5 and the rotary body 6 tightly abut each other. More specifically, the resilient member 111 resiliently urges cam surfaces 142 and contact sections 143, both of which are portions of a cam mechanism 141, which will be described later, so as to tightly abut each other. In the embodiment, a coil spring 8 forms the resilient member 111.

The holding means 120 holds the pressing body 5 at the press releasing position between the first rotary position (see FIGS. 2 and 3) and the second rotary position (see FIGS. 4 and 5). Specifically, the holding means 120 has an urging body 121 that urges (more specifically, resiliently urges) the pressing body 5 in a direction in which the pressing body 5 moves from the pressing position to the press releasing position. In other words, the pressing body 5 is urged by the urging body 121 toward the press releasing position side to be held at the press releasing position between the first rotary position and the second rotary position. In the embodiment, the coil spring 8 forms the urging body 121. That is, the coil spring 8 functions as both of the resilient member 111 and the urging body 121.

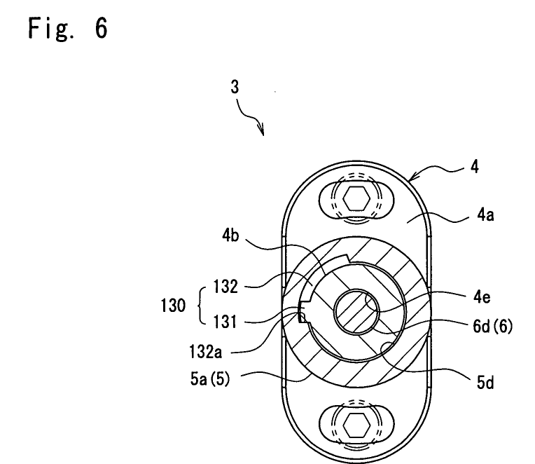

The rotary range limiting means 130 prevents the pressing body 5 from rotating to a side opposite the first rotary position from the second rotary position. Specifically, the rotary range limiting means 130 includes a projection 131 projecting from one of the base body 4 and the pressing body 5 (in the embodiment, projecting from the base body 4) and a recess 132 in the other of the base body 4 and the pressing body 5 (in the embodiment, in the pressing body 5) to accommodate the projection 131 and also to allow the projection 131 to move relative to the recess 132. For example, the recess 132 is defined by a hollow, a hole, a notch or the like. When the pressing body 5 rotates from the first rotary position (see FIGS. 2 and 3) to the second rotary position (see FIGS. 4 and 5), the projection 131 moves relative to and in the recess 132 and abuts an end surface 132a of the recess 132 so that the pressing body 5 is prevented from moving further (see FIG. 6).

The interlocking means 140 moves the pressing body 5 positioned at the second rotary position between the press releasing position (see FIG. 5) and the pressing position (see FIG. 8) in interlocking with the rotational movement of the rotary body 6 between the middle rotary position (see FIGS. 4 and 5) and the other rotary position (see FIGS. 7 and 8). The interlocking means 140 includes a cam mechanism 141 having the cam surfaces 142 and the contact sections 143 contacting the cam surfaces 142. The cam mechanism 141 is configured in such a manner that the cam surfaces 142 and the contact sections 143 have surface contact with each other at least when the pressing body 5 is positioned at the pressing position. Specifically, the interlocking means 140 includes the cam mechanism 141 configured between the pressing body 5 and the rotary body 6. One of the pressing body 5 and the rotary body 6 (in the embodiment, the pressing body 5) has the cam surfaces 142 and the other thereof (in the embodiment, the rotary body 6) has the contact section 143.

In this cam mechanism 141, an inclination of each cam surface 142 is formed to move the pressing body 5 rapidly on the side of the middle rotary position and to move the pressing body 5 slowly on the side of the other rotary position in the rotational movement of the rotary body 6 between the middle rotary position and the other rotary position. That is, each cam surface 142 has a larger inclining angle on the side of the middle rotary position (corresponding to a second cam surface 142b which will be described later), while the cam surface 142 has a smaller inclining angle on the side of the other rotary position (corresponding to a third cam surface 142c which will be described later also).

Specifically, the base body 4 has a plate-like basal section 4a and a column section 4b extending perpendicularly upward from a center portion of the basal section 4a and having a columnar shape. The column section 4b has the axis 7. In this embodiment, the basal section 4a has apertures 4c, 4c into which fixing bolts 9 are inserted. The apertures 4c, 4c are used for fixing the basal section 4a to the fixing base 1. The base body 4 has a through-hole 4d extending through the column section 4b and the basal section 4a. The through-hole 4d extends coaxially with a circumferential surface of the column section 4b. That is, the axis of the through-hole 4d is coincident with the axis 7. The through-hole 4d is formed with a middle axial hollow 4e, a first opening 4f positioned on the side of the basal section 4a and having an inner diameter larger than an inner diameter of the axial hollow 4e, and a second opening 4g positioned on the side of its top end and having an inner diameter larger than the inner diameter of the axial hollow 4e. The coil spring 8 is inserted into the second opening 4g to resiliently urge the pressing body 5 upward, as will be described later. The projection 131 of the rotary range limiting means 130 extends from an outer circumferential surface of the column section 4b.

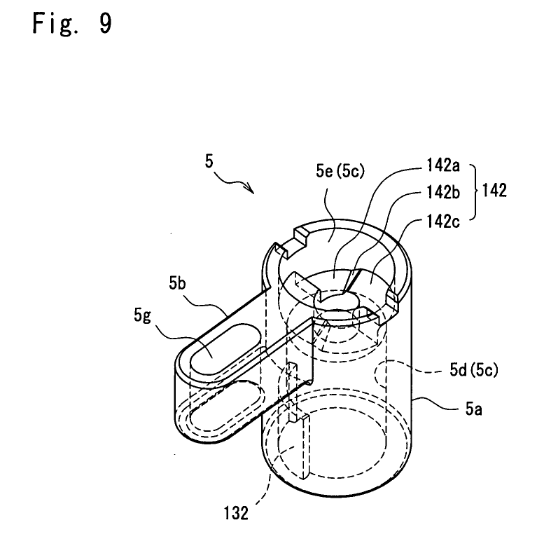

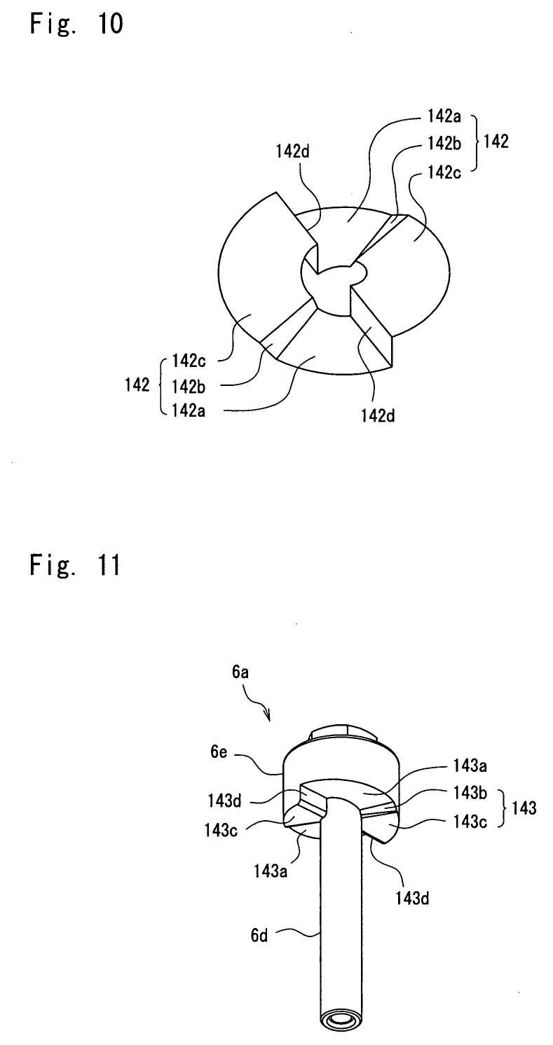

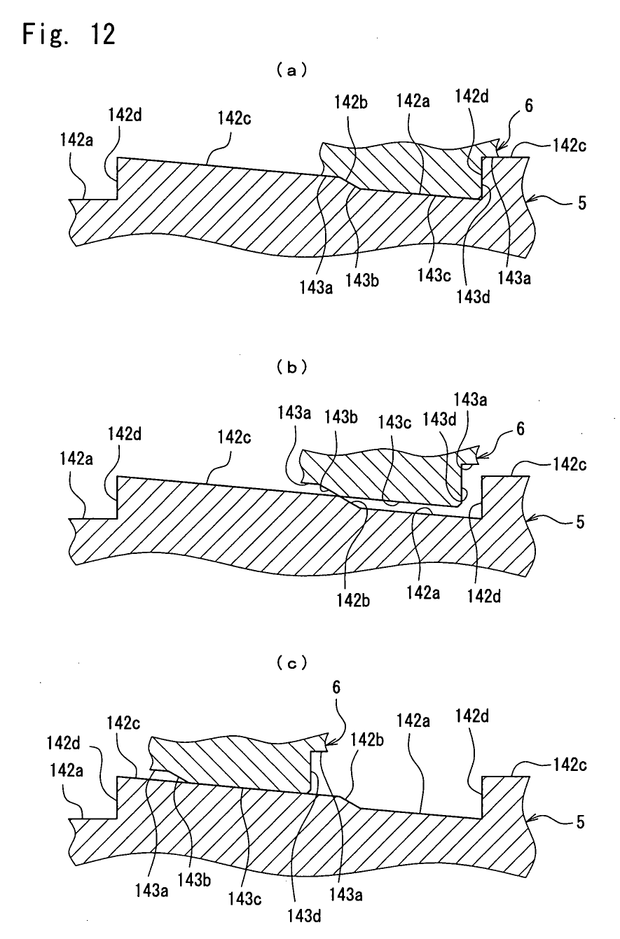

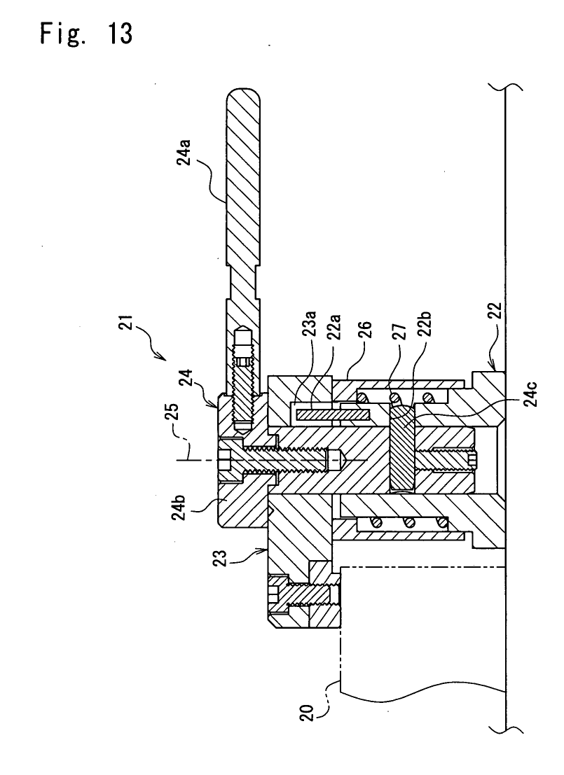

The pressing body 5 has a tubular section 5a and a protruding section 5b that protrudes sideward from an upper portion of the tubular section 5a. A bore 5c of the tubular section 5a has the axis 7 and is formed with a lower axial hollow 5d, an upper opening 5e and a communicating hollow 5f connecting the axial hollow 5d and the opening 5e to each other and having a smaller inner diameter. An inner circumferential surface of the axial hollow 5d has the recess 132 of the rotary range limiting means 130. The axial hollow 5d of the pressing body 5 is put onto the outer circumferential surface of the column section 4b of the base body 4, and the projection 131 of the base body 4 is accommodated in the recess 132 of the pressing body 5. Thereby, the pressing body 5 can rotate about the axis 7 relative to the base body 4 within the range where the projection 131 is allowed to move inside the recess 132. A bottom surface of the opening 5e has the cam surfaces 142 of the interlocking means 140 (see FIG. 9). Each cam surface 142 includes: a first cam surface 142a ascending with the inclination of five degrees; the second cam surface 142b continuing from the first cam surface 142a and ascending with the inclination of 30 degrees; and the third cam surface 142c continuing from the second cam surface 142b and ascending with the inclination of five degrees (see FIGS. 10 and 12). Two cam surfaces 142 are provided, spaced from each other by 180 degrees about the axis 7. A terminal end of one cam surface 142 and a starting end of the other cam surface 142 join together at a rising surface 142d. The protruding section 5b is a portion that faces the workpiece 2 in the same direction as the direction of the axis 7 when the pressing body 5 reaches the second rotary position after rotating. In the illustrated embodiment, the protruding section 5b has a slot 5g. A mouthpiece 5h for pressing the workpiece 2 is inserted into the slot 5g thereby to be fixed.

The rotary body 6 includes a camshaft 6a defining the axis 7 and an operating lever 6c fastened to the camshaft 6a by a bolt 6b. The operating lever 6c can be fixed at any appropriate position about the axis of the camshaft 6a (i.e., about the axis 7). The position of the operating lever 6c thus can be changed in accordance with a usage condition of the clamping device 3. The camshaft 6a includes an axial section 6d and a head section 6e having an outer diameter larger than an outer diameter of the axial section 6d. Thus, the axial section 6d is inserted into the axial hollow 4e of the base body 4 and the communicating hollow 5f of the pressing body 5, and the head section 6e is inserted into the opening 5e of the pressing body 5. Thereby, the rotary body 6 can rotate about the axis 7 relative to the base body 4 and the pressing body 5. In this state, a washer 6f is fastened to a bottom end of the axial section 6d by a bolt 6g within the first opening 4f of the base body 4 so that the rotary body 6 is prevented from coming off from the base body 4. A bottom surface of the head section 6e has the contact section 143 of the interlocking means 140 projecting from the bottom surface (see FIG. 11). Two contact sections 143 are provided, spaced from each other by 180 degrees about the axis 7 to correspond to the cam surfaces 142. Each contact section 143 is formed with a first contact section 143b ascending with the inclination of 30 degrees from the bottom surface 143a and a second contact section 143c ascending with the inclination of five degrees continuing from the first contact section 143b (see FIGS. 11 and 12). A terminal end of the second contact section 143c and the bottom surface 143a join together via a rising surface 143d. As thus constructed, each protruding portion formed with the first contact section 143b, the second contact section 143c and the rising surface 143d fits in a corresponding recessed portion defined by the second cam surface 142b, the first cam surface 142a and the rising surface 142d of the pressing body 5, when the rotary body 6 is positioned at the one rotary position (see FIG. 12(a)). The contact means 110 (coil spring 8) keeps this condition while the rotary body 6 rotates from the one rotary position to the middle rotary position. The pressing body 5 rotates as the rotary body 6 rotates.

Next, actions and effects of the clamping device 3 having the construction discussed above will be described below. Regarding this clamping device 3, when the rotary body 6 is rotated from the one rotary position (see FIGS. 2 and 3) to the middle rotary position (see FIGS. 4 and 5), the pressing body 5 rotates from the first rotary position to the second rotary position as the rotary body 6 is rotated by the contact means 110, while being held at the press releasing position by the holding means 120. In addition, when the rotary body 6 is rotated from the middle rotary position (see FIGS. 4 and 5) to the other rotary position (see FIGS. 7 and 8), the pressing body 5 is moved from the press releasing position to the pressing position by the interlocking means 140, while being held at the second rotary position by the rotary range limiting means 130, to press the workpiece 2. Because the interlocking means 140 has the cam mechanism 141 in this embodiment, first, each first contact section 143b of the cam mechanism 141 ascends relative to the associated second cam surface 142b having the larger inclination angle (FIG. 12(a) shows a condition before the first contact section 143b starts ascending). When the first contact section 143b reaches the top of the second cam surface 142b (see FIG. 12(b)), next, the second contact section 143c ascends relative to the third cam surface 142c having the smaller inclination angle (see FIG. 12(c)). The pressing body 5 presses the workpiece 2 while the second contact section 143c ascends the third cam surface 142c. Thereby, the pressing body 5 rapidly moves by the second cam surface 142b from the press releasing position toward the pressing position side and strongly presses the workpiece 2 at the pressing position by the third cam surface 142c.

That is, when the workpiece 2 is fixed to the fixing base 1, the rotary body 6 is operated to rotate from the one rotary position to the other rotary position beyond the middle rotary position after the workpiece 2 is placed at the position where the workpiece 2 is to be fixed. Thereby, the pressing body 5 rotates from the first rotary position (see FIGS. 2 and 3) at which the pressing body 5 does not face the workpiece 2 to the second rotary position (see FIGS. 4 and 5) at which the pressing body 5 faces the workpiece 2 as the rotary body 6 rotates to the middle rotary position. Then, with the rotational movement of the rotary body 6 to the other rotary position, the pressing body 5 moves from the press releasing position (see FIG. 5) on the press releasing side to the pressing position (see FIG. 8) on the pressing side, while staying at the second rotary position, to press the workpiece 2. Thus, workpiece 2 is fixed to the fixing base 1.

On the other hand, when the rotary body 6 is rotated from the other rotary position to the one rotary position side, the pressing body 5 is moved from the pressing position to the press releasing position side by the interlocking means 140, and the pressing body 5 is rotated from the second rotary position to the first rotary position by the contact means 110 as the rotary body 6 rotates. That is, when the workpiece 2 is removed from the fixing base 1, the rotary body 6 is operated to rotate from the other rotary position to the one rotary position. Thereby, the pressing body 5 moves from the pressing position to the press releasing position side and rotates from the second rotary position at which the pressing body 5 faces the workpiece 2 to the first rotary position at which the pressing body 5 does not face the workpiece 2. Afterwards, the workpiece 2 is removed from the fixing base 1.

As thus described, regarding the clamping device 3, when the workpiece 2 is placed on the fixing base 1 to be fixed thereto or is removed from the fixing base 1, by operating the rotary body 6 to rotate, the pressing body 5 rotates between the first rotary position at which the pressing body 5 does not face the workpiece 2 and the second rotary position at which the pressing body 5 faces the workpiece 2 and also moves between the press releasing position on the press releasing side and the pressing position on the pressing side. Therefore, the workpiece 2 can be easily fixed to the fixing base 1 or removed therefrom. Also, as shown in FIG. 12(c), the cam mechanism 141 of the interlocking means 140 is configured in such a manner that the cam surface 142 (specifically, the third cam surface 142c) and the contact section 143 (specifically, the second contact section 143c) have surface contact with each other when the pressing body 5 presses the workpiece 2, i.e., when the pressing body 5 is located at the pressing position. The pressing load by which the workpiece 2 is pressed thus can be easily increased.

When the rotary body 6 is rotated between the one rotary position and the middle rotary position, and the cam surface 142 (specifically, the second cam surface 142b and the first cam surface 142a, and particularly the second cam surface 142b) and the contact section 143 (specifically, the first contact section 143b and the second contact section 143c, and particularly the first contact section 143b) tightly abut each other, the pressing body 5 rotates between the first rotary position and the second rotary position, as the rotary body 6 rotates. No contact portion thus is necessary other than the cam mechanism 141.

By placing the cam mechanism 141 that functions as the interlocking means 140 between the pressing body 5 and the rotary body 6, the pressing body 5 moves relative to the rotary body 6 in the same direction as the direction of the axis 7. Therefore, the pressing body 5 can move between the press releasing position and the pressing position without the rotary body 6 being moved in the same direction as the direction of the axis 7. That is, neither the rotary body 6 moves in connection with the base body 4 in the same direction as the direction of the axis 7, nor the pressing body 5 moves with such movement of the rotary body 6 in the same direction as the direction of the axis 7. In this embodiment, the pressing body 5 moves in connection with the rotary body 6 in the same direction as the direction of the axis 7. Because the rotary body 6 does not move in the same direction as the direction of the axis 7 as discussed above to fix the workpiece 2, the rotary body 6 can be easily operated.

The scope of this invention is not limited to the embodiment described above and may include various other modifications, variations and alternatives. For example, the fixing base 1 may be a pallet for machining center, a machine table or other tables other than the fixture base. Also, the object to be clamped may be, for example, a jig, a fixture, a metal mold, etc. other than the workpiece 2.

The pressing body 5 has the cam surfaces 142 and the rotary body 6 has the contact sections 143 in the cam mechanism 141. Conversely, however, the rotary body 6 may have the cam surfaces and the pressing body 5 may have the contact sections.

The interlocking means 140 can include other mechanisms than the cam mechanism 141 configured between the pressing body 5 and the rotary body 6. For example, the interlocking means 140 may include a cam mechanism configured between the rotary body 6 and the base body 4, e.g., between the washer 6f of the rotary body 6 and the bottom surface of the first opening 4f of the base body 4. In this alternative cam mechanism, as the rotary body 6 rotates, the rotary body 6 moves in the same direction as the direction of the axis 7 relative to the base body 4. Together with the rotary body 6 that moves, the pressing body 5 moves in the same direction as the direction of the axis 7 (i.e., between the press releasing position and the pressing position).

Although the mouthpiece 5h is fastened to the protruding section 5b of the pressing body 5, the protruding section 5b may directly press the workpiece 2 without the mouthpiece 5h being provided.

Another lever that controls torque (where torque amounts are indicated) may replace the operating lever 6c of the rotary body 6.

The rotary range limiting means 130 may include other components than the projection 131 and the recess 132. For example, the rotary range limiting means 130 may include a first projection projecting from one of the base body 4 and the pressing body 5 and a second projection projecting from the other thereof. The first and second projections may abut each other at the second rotary position of the pressing body 5. In another alternative, the rotary range limiting means 130 may include the protruding section 5b of the pressing body 5 and an extending section that extends from the base body 4 to abut the protruding section 5b located at the second rotary position.

1. A clamping device for fixing an object to be clamped to a fixing base, comprising:
a base body detachably fixed to the fixing base;
a pressing body for pressing the object; and
a rotationally operable rotary body,
the base body, the pressing body and the rotary body being coupled with each other for rotational movement relative to each other about an axis, the pressing body being rotatable between a first rotary position at which the pressing body does not face the object in the same direction as a direction of the axis and a second rotary position at which the pressing body faces the object in the same direction as the direction of the axis, the rotary body being rotatable between one rotary position on a side of the first rotary position and another rotary position beyond a middle rotary position on a side of the second rotary position,
the pressing body being movable between a press releasing position on a press releasing side and a pressing position on a pressing side, in the same direction as the direction of the axis, so that the pressing body presses the object and releases the pressing at the second rotary position,
the clamping device further comprising:
a contact means for making the pressing body and the rotary body contact each other so that the pressing body rotates as the rotary body rotates between the first rotary position and the second rotary position;
a holding means for holding the pressing body at the press releasing position between the first rotary position and the second rotary position;
a rotary range limiting means for preventing the pressing body from rotating to a side opposite the first rotary position from the second rotary position; and
an interlocking means for moving the pressing body positioned at the second rotary position between the press releasing position and the pressing position in interlocking with the rotational movement of the rotary body between the middle rotary position and the other rotary position,
the interlocking means including a cam mechanism having a cam surface and a contact section contacting the cam surface, the cam mechanism is configured in such a manner that the cam surface and the contact section have surface contact with each other at least when the pressing body is positioned at the pressing position,
wherein, when the rotary body is rotated from the one rotary position to the middle rotary position, the pressing body rotates from the first rotary position to the second rotary position as the rotary body is rotated by the contact means, while being held at the press releasing position by the holding means, and, when the rotary body is rotated from the middle rotary position to the other rotary position, the pressing body is moved from the press releasing position to the pressing position by the interlocking means, while being held at the second rotary position by the rotary range limiting means, to press the object.

2. The clamping device according to claim 1, wherein the interlocking means comprises the cam mechanism, one of the pressing body and the rotary body has the cam surface and the other thereof has the contact section.

3. The clamping device according to claim 2, wherein the contact means comprises a resilient member which resiliently urges so that the cam surface and the contact section tightly abut each other.

4. The clamping device according to claim 1, wherein the cam surface of the cam mechanism has an inclination formed to move the pressing body rapidly on the side of the middle rotary position and to move the pressing body slowly on the side of the other rotary position in the rotational movement of the rotary body between the middle rotary position and the other rotary position.

5. The clamping device according to claim 1, wherein the rotary range limiting means comprises a projection projecting from one of the base body and the pressing body and a recess in the other of the base body and the pressing body to allow the projection to move relative to the recess, and
when the pressing body rotates from the first rotary position to the second rotary position, the projection moves relative to and in the recess and abuts an end surface of the recess so that the pressing body is prevented from moving further.

6. The clamping device according to claim 1, wherein the holding means comprises an urging body that urges the pressing body in a direction in which the pressing body moves from the pressing position to the press releasing position.

7. The clamping device according to claim 1, wherein the rotary body comprises a camshaft defining the axis and an operating lever fixed to the camshaft by a bolt.

8. The clamping device according to claim 1, further comprising another cam surface, the cam surfaces being spaced from each other by 180 degrees about the axis, and another contact section, the contact sections being spaced from each other by 180 degrees about the axis to correspond to the cam surfaces.
